(19) United States
(12) Patent Application Publication
(10) Pub. No.: US 2026/0238353 A1
(43) Pub. Date: Aug. 13, 2026

(54) METHOD AND SYSTEM FOR IMPROVED ACOUSTIC TRANSMISSION OF DATA

(71) Applicant: Sonos Experience Limited, Hayes (GB)

(72) Inventors: Daniel John JONES, London (GB); James Andrew Nesfield, London (GB)

(21) Appl. No.: 19/296,230

(22) Filed: Aug. 11, 2025

Related U.S. Application Data
(63) Continuation of application No. 18/405,045, filed on Jan. 5, 2024, now Pat. No. 12,388,539.
Application No. 18/405,045 is a continuation of application No. 16/956,905, filed on Dec. 20, 2018, now Pat. No. 11,870,501.

(30) Foreign Application Priority Data
Dec. 20, 2017 (GB) 1721457.8

(51) Int. Cl. H04B 11/00

(52) U.S. Cl. CPC H04B 11/00

(57) ABSTRACT

The present invention relates to a method for communicating data acoustically. The method includes segmenting the data into a sequence of symbols; encoding each symbol of the sequence into a plurality of tones; and acoustically generating the plurality of tones simultaneously for each symbol in sequence. Each of the plurality of tones for each symbol in the sequence may be at a different frequency.

### FIELD OF INVENTION

The present invention is in the field of data communication. More particularly, but not exclusively, the present invention relates to a method and system for acoustic transmission of data.

### BACKGROUND

There are a number of solutions to communicating data wirelessly over a short range to and from devices using radio frequencies. The most typical of these is WiFi. Other examples include Bluetooth and Zigbee.

An alternative solution for a short range data communication uses a “transmitting” speaker and “receiving” microphone to send encoded data acoustically over-the-air.

Such an alternative may provide various advantages over radio frequency-based systems. For example, speakers and microphones are cheaper and more prevalent within consumer electronic devices, and acoustic transmission is limited to “hearing” distance.

There exist several over-the-air acoustic communications systems. A popular scheme amongst over-the-air acoustic communications systems is to use Frequency Shift Keying as the modulation scheme, in which digital information is transmitted by modulating the frequency of a carrier signal to convey 2 or more integer levels (M-ary fixed keying, where M is the distinct number of levels).

One such acoustic communication system is described in US Patent Publication No. US2012/084131A1, DATA COMMUNICATION SYSTEM. This system, invented by Patrick Bergel and Anthony Steed, involves the transmission of data using an audio signal transmitted from a speaker and received by a microphone where the data, such as a shortcode, is encoded into a sequence of tones within the audio signal.

Acoustic communication systems using Frequency Shift Keying such as the above system can have a good level of robustness but are limited in terms of their throughput. The data rate is linearly proportional to the number of tones available (the alphabet size), divided by the duration of each tone. This is robust and simple in complexity, but is spectrally inefficient.

Radio frequency data communication systems may use phase- and amplitude-shift keying to ensure high throughput. However, both these systems are not viable for over-the-air data transmission in most situations, as reflections and amplitude changes in real-world acoustic environments renders them extremely susceptible to noise.

There is a desire for a system which provides improved throughput in acoustic data communication systems.

It is an object of the present invention to provide a method and system for improved acoustic data transmission which overcomes the disadvantages of the prior art, or at least provides a useful alternative.

### SUMMARY OF INVENTION

According to a first aspect of the invention there is provided a method for communicating data acoustically, including:
a) Segmenting the data into a sequence of symbols;
b) Encoding each symbol of the sequence into a plurality of tones; and
c) Acoustically generating the plurality of tones simultaneously for each symbol in sequence;
wherein each of the plurality of tones for each symbol in the sequence are at a different frequency.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows block diagram illustrating a data communication system in accordance with an embodiment of the invention; and

FIG. 2: shows a flow diagram illustrating a data communication method in accordance with an embodiment of the invention.

### DETAILED DESCRIPTION OF PREFERRED EMBODIMENTS

The present invention provides an improved method and system for acoustically communicating data.

The inventors have discovered that throughput can be increased significantly in a tone-based acoustic communication system by segmenting the data into symbols and transmitting K tones simultaneously for each symbol where the tones are selected from an alphabet of size M. In this way, a single note comprising multiple tones can encode symbols of size 1092 (M choose K) bits compared to a single tone note which encodes a symbol into only 1092 (M) bits. The inventors have discovered that this method of increasing data density is significantly less susceptible to noise in typical acoustic environments compared to PSK and ASK at a given number of bits per symbol.

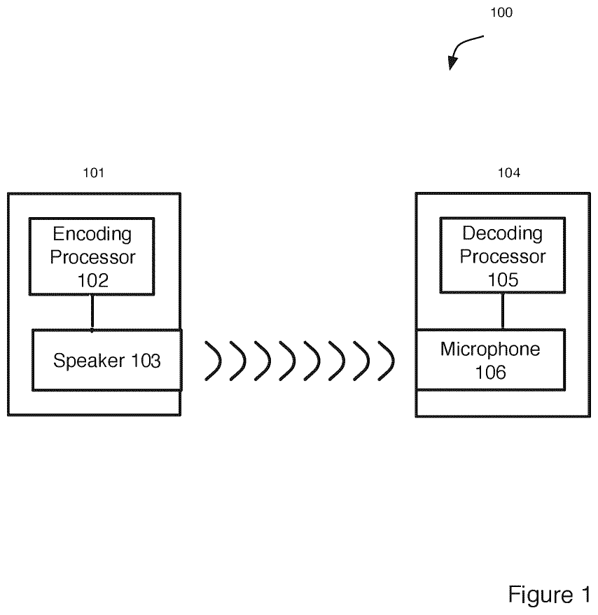

In FIG. 1, an acoustic data communication system 100 in accordance with an embodiment of the invention is shown.

The system 100 may include a transmitting apparatus 101 comprising an encoding processor 102 and a speaker 103.

The encoding processor 102 may be configured for segmenting data into a sequence of symbols and for encoding each symbol of the sequence into a plurality of tones. Each symbol may be encoded such that each of the plurality of tones are different. Each symbol may be encoded into K tones. The data may be segmented into symbols corresponding to B bits of the data. B may be log2 (M choose K) where M is the size of the alphabet for the tones. The alphabet of tones may be spread evenly over a frequency spectrum or may be spread in ways to improve transmission.

The processor 102 and/or speaker 103 may be configured for acoustically transmitting the plurality of tones simultaneously for each symbol in sequence. For example, the processor 102 may be configured for summing the plurality of tones into a single note or chord for generation at the speaker 103. Alternatively, the speaker 103 may include a plurality of cones and each cone may generate a tone.

The system 100 may include a receiving apparatus 104 comprising a decoding processor 105 and a microphone 106.

The microphone 106 may be configured for receiving an audio signal which originates at the speaker 103.

The decoding processor 105 may be configured for decoding the audio signal into a sequence of notes (or chords), for identifying a plurality of tones within
each note, for decoding the plurality of tones for each note into a symbol to form a sequence of symbols, and for reconstituting data from the sequence of symbols.

It will also be appreciated by those skilled in the art that the above embodiments of the invention may be deployed on different apparatuses and in differing architectures. For example, the encoding processor 102 and speaker 103 may exist within different devices and the audio signal to be generated may be transmitted from the encoding processor 102 (e.g. the processor 102 may be located at a server) to the speaker 103 (e.g. via a network, or via a broadcast system) for acoustic generation (for example, the speaker 103 may be within a television or other audio or audio/visual device). Furthermore, the microphone 106 and decoding processor 105 may exist within different devices. For example, the microphone 106 may transmit the audio signal, or a representation thereof, to a decoding processor 105 in the cloud.

The functionality of the apparatuses 101 and 104 and/or processors 102 and 105 may be implemented, at least in part, by computer software stored on an intangible computer-readable medium.

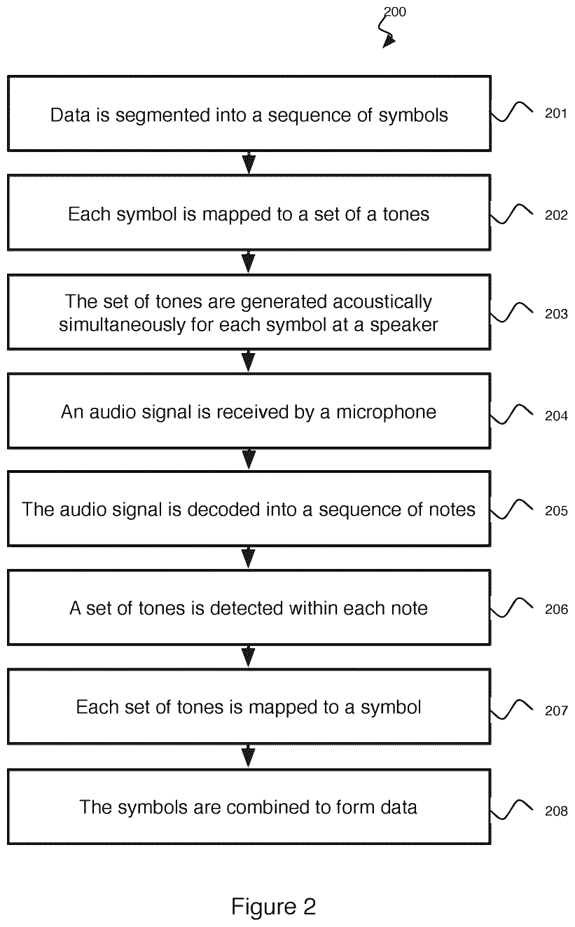

Referring to FIG. 2, a method 200 for communicating data acoustically will be described.

The data may be comprised of a payload and error correction. In some embodiment, the data may include a header. The header may include a length related to the transmission (e.g. for the entire data or the payload). The length may be the number of symbols transmitted.

In step 201, the data is segmented into a sequence of symbols (e.g. at transmitting apparatus 101 by encoding processor 102). The data may be segmented by first treating the data as a stream of bits. The segment size (B) in bits may be determined by:

B=log₂ (M choose K)

M is the size of the alphabet of the tones at different frequencies spanning an audio spectrum and K is the number of tones per note or chord.

The audio spectrum may be wholly or, at least partially, audible to human beings (e.g. within 20 Hz to 20 kHz), and/or may be wholly, or at least partially, ultrasonic (e.g. above 20 kHz). In one embodiment, the audio spectrum is near-ultrasonic (18 kHz to 20 kHz).

In step 202, each symbol in the sequence may be mapped to a set of tones (e.g. at transmitting apparatus 101 by encoding processor 102). Each set may comprise K tones. The tones may be selected from the alphabet of M tones. Preferably each tone within a set is a different tone selected from the alphabet. The symbol may be mapped to the set of tones via bijective mapping. In one embodiment, a hash-table from symbol to tone set may be used to encode the symbol (a second hash-table may map the set of tones to symbol to decode a detected set of tones). One disadvantage of using hash-tables is that because the hash-table must cover all possible selections of tones for the set, as M and/or K increases, the memory requirements may become prohibitively large. Therefore, it may be desirable if a more efficient bijective mapping schema could be used. One embodiment, which addresses this desire, uses a combinatorial number system (combinadics) method to map symbols to tone sets and detected tone sets to symbols.

In the combinadics method, each symbol (as an integer) can be translated into a K-value combinatorial representation (e.g. a set of K tones selected from the alphabet of M tones). Furthermore, each set of K tones can be translated back into a symbol (as an integer).

In step 203, the set of tones may be generated acoustically simultaneously for each symbol in the sequence (e.g. at the transmitting apparatus 101). This may be performed by summing all the tones in the set into an audio signal and transmitting the audio signal via a speaker 103. The audio signal may include a preamble. The preamble may assist in triggering listening or decoding at a receiving apparatus (e.g. 104). The preamble may be comprised of a sequence of single or summed tones.

In step 204, the audio signal may be received by a microphone (e.g. 106 at receiving apparatus 104).

In step 205, the audio signal may be decoded (e.g. via decoding processor 105) into a sequence of notes. Decoding of the audio signal may be triggered by detection first of a preamble.

Each note may comprise a set of tones and the set of tones may be detected within each node (e.g. by decoding processor) in step 206. The tones may be detected by computing a series of FFT frames for the audio signal corresponding to a note length and detecting the K most significant peaks in the series of FFT frames. In other embodiments, other methods may be used to detect prominent tones.

The set of detected tones can then be mapped to a symbol (e.g. via a hash-table or via the combinadics method described above) in step 207.

In step 208, the symbols can be combined to form data. For example, the symbols may be a stream of bits that is segmented into bytes to reflect the original data transmitted.

At one or more of the steps 205 to 208, error correction may be applied to correct errors created during acoustic transmission from the speaker (e.g. 103) to the microphone (e.g. 106). For example, forward error correction (such as Reed-Solomon) may form a part of the data and may be used to correct errors in the data.

Embodiments of the present invention will be further described below:

### Symbols, Lexical Mappings and the Combinatorial Number System (Combinadics)

In monophonic M-ary FSK, each symbol can represent M different values, so can store at most log2M bits of data. Within multi-tone FSK, with a chord size of K and an alphabet size of M, the number of combinatoric selections is M choose K:

$$M ! / ( K ! ( M - K ) ! )$$

Thus, for an 6-bit (64-level) alphabet and a chord size K of 4, the total number of combinations is calculated as follows:

$$64 ! / ( 4 ! 60 ! ) = 635 , 376$$

Each symbol should be expressible in binary. The 1092 of this value is taken to deduce the number of combinations that can be expressed, which is in this case 2¹⁹. The spectral efficiency is thus improved from 6-bit per symbol to 19-bit per symbol.

### Combinadics

To translate between K-note chords and symbols within the potential range, a bijective mapping must be created between the two, allowing a lexographic index A to be derived from a combination {X₁, X₂, . . . . Xₖ} and vice-versa.

A naive approach to mapping would work by:
generating all possible combinations, and
storing a pair of hashtables from A<-> {X₁, X₂, . . . Xₖ}

Example for M=4, K=3

$$0 - \{ 0 , 1 , 2 \}$$

$$1 - \{ 0 , 1 , 3 \}$$

$$2 - \{ 0 , 1 , 4 \}$$

$$3 - \{ 0 , 2 , 3 \}$$

$$4 - \{ 0 , 2 , 4 \}$$

$$5 - \{ 0 , 3 , 4 \}$$

$$6 - \{ 1 , 2 , 3 \}$$

$$7 - \{ 1 , 2 , 4 \}$$

$$8 - \{ 1 , 3 , 4 \}$$

$$9 - \{ 2 , 3 , 4 \}$$

As the combinatoric possibilities increase, such as in the above example, the memory requirements become prohibitively large. Thus, an approach is needed that is efficient in memory and CPU.

Mapping from Data to Combinadics to Multi-Tone FSK

To therefore take a stream of bytes and map it to a multi-tone FSK signal, the process is as follows:
segment the stream of bytes into B-bit symbols, where 28 is the maximum number of binary values expressible within the current combinatoric space (e.g. M choose K)
translate each symbol into its K-value combinatorial representation
synthesize the chord by summing the K tones contained within the combination

In one embodiment, a transmission “frame” or packet may be ordered as follows:
1. Preamble/wakeup symbols (F)
2. Payload symbols (P)
3. Forward error-correction symbols (E)
FF PPPPPPPP EEEEEEEE

At decoding, a receiving may:
decode each of the constituent tones using an FFT.
segment the input into notes, each containing a number of FFT frames equal to the entire expected duration of the note.
use a statistical process to derive what seem to be the K most prominent tones within each note
translate the K tones into a numerical symbol using the combinatorial number system process described above
concatenate the symbols to the entire length of the payload (and FEC segment)
re-segment into bytes.
and finally, apply the FEC algorithm to correct any mis-heard tones

In another embodiment, the FEC algorithm may be applied before re-segmentation into bytes.

A potential advantage of some embodiments of the present invention is that data throughput for acoustic data communication systems can be significantly increased (bringing throughput closer to the Shannon limit for the channel) in typical acoustic environments by improved spectral efficiency. Greater efficiency results in faster transmission of smaller payloads, and enables transmission of larger payloads which previously may have been prohibitively slow for many applications.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. An apparatus comprising:
a microphone;
one or more processors; and
a non-transitory, computer-readable medium storing instructions that, when executed by the one or more processors, cause the apparatus to:
receive, via the microphone, an acoustic signal comprising data represented as a sequence of notes, each note comprising a plurality of simultaneous tones;
for each note in the sequence, perform a time-frequency analysis of the respective plurality of simultaneous tones to identify a set of K most prominent frequency peaks;
determine a symbol value for each identified set of K most prominent frequency peaks to obtain a plurality of symbol values, wherein the symbol value is determined by performing a bijective mapping on the respective identified set, wherein the bijective mapping is calculated via a combinatorial number system to derive a lexographic index corresponding to the respective identified set;
identify a sequence of symbols corresponding to the plurality of symbol values; and
reconstitute the data from the sequence of symbols.

2. The apparatus of claim 1, wherein identifying the set of K most prominent frequency peaks comprises:
computing a plurality of Fast Fourier Transform (FFT) frames based on the acoustic signal; and
selecting K frequencies with the highest average magnitude across the plurality of FFT frames.

3. The apparatus of claim 1, wherein the bijective mapping is performed without a pre-stored lookup table for all possible combinations of the K tones by calculating a sum of binomial coefficients based on the identified frequencies.

4. The apparatus of claim 1, wherein the identified set of K most prominent frequency peaks are selected from a set of available frequencies spread evenly over a frequency spectrum according to a log-frequency scale.

5. The apparatus of claim 1, wherein the instructions further cause the apparatus to:
identify a preamble sequence within the acoustic signal, the preamble sequence comprising a specific temporal pattern of single tones that indicates the beginning of the sequence of notes.

6. The apparatus of claim 5, wherein the instructions further cause the apparatus to:
based on identification of the preamble sequence within the acoustic signal, initiate decoding the acoustic signal into the sequence of notes.

7. The apparatus of claim 1, wherein the plurality of simultaneous tones comprises at least three tones.

8. A non-transitory computer-readable medium storing instructions that, when executed by one or more processors, cause an apparatus to:
receive, via a microphone, an acoustic signal comprising data represented as a sequence of notes, each note comprising a plurality of simultaneous tones;
for each note in the sequence, perform a time-frequency analysis of the respective plurality of simultaneous tones to identify a set of K most prominent frequency peaks;
determine a symbol value for each identified set of K most prominent frequency peaks to obtain a plurality of symbol values, wherein the symbol value is determined by performing a bijective mapping on the respective identified set, wherein the bijective mapping is calculated via a combinatorial number system to derive a lexographic index corresponding to the respective identified set;
identify a sequence of symbols corresponding to the plurality of symbol values; and
reconstitute the data from the sequence of symbols.

9. The apparatus of claim 8, wherein identifying the set of K most prominent frequency peaks comprises:
computing a plurality of Fast Fourier Transform (FFT) frames based on the acoustic signal; and
selecting K frequencies with the highest average magnitude across the plurality of FFT frames.

10. The apparatus of claim 8, wherein the bijective mapping is performed without a pre-stored lookup table for all possible combinations of the K tones by calculating a sum of binomial coefficients based on the identified frequencies.

11. The apparatus of claim 8, wherein the identified set of K most prominent frequency peaks are selected from a set of available frequencies spread evenly over a frequency spectrum according to a log-frequency scale.

12. The apparatus of claim 8, wherein the instructions further cause the apparatus to:
identify a preamble sequence within the acoustic signal, the preamble sequence comprising a specific temporal pattern of single tones that indicates the beginning of the sequence of notes.

13. The apparatus of claim 12, wherein the instructions further cause the apparatus to:
based on identification of the preamble sequence within the acoustic signal, initiate decoding the acoustic signal into the sequence of notes.

14. The apparatus of claim 8, wherein the plurality of tones comprises at least three tones.

15. A method, comprising:
receiving, via a microphone, an acoustic signal comprising data represented as a sequence of notes, each note comprising a plurality of simultaneous tones;
for each note in the sequence, performing a time-frequency analysis of the respective plurality of simultaneous tones to identify a set of K most prominent frequency peaks;
determining a symbol value for each identified set of K most prominent frequency peaks to obtain a plurality of symbol values, wherein the symbol value is determined by performing a bijective mapping on the respective identified set, wherein the bijective mapping is calculated via a combinatorial number system to derive a lexographic index corresponding to the respective identified set;
identifying a sequence of symbols corresponding to the plurality of symbol values; and
reconstituting the data from the sequence of symbols.

16. The method of claim 15, wherein identifying the set of K most prominent frequency peaks comprises:
computing a plurality of Fast Fourier Transform (FFT) frames based on the acoustic signal; and
selecting K frequencies with the highest average magnitude across the plurality of FFT frames.

17. The method of claim 15, wherein the bijective mapping is performed without a pre-stored lookup table for all possible combinations of the K tones by calculating a sum of binomial coefficients based on the identified frequencies.

18. The method of claim 15, wherein the identified set of K most prominent frequency peaks are selected from a set of available frequencies spread evenly over a frequency spectrum according to a log-frequency scale.

19. The method of claim 15, further comprising:
identifying a preamble sequence within the acoustic signal, the preamble sequence comprising a specific temporal pattern of single tones that indicates the beginning of the sequence of notes.

20. The method of claim 19, further comprising:
based on identification of the preamble sequence within the acoustic signal, initiating decoding of the acoustic signal into the sequence of notes.
